(19) United States
(12) Patent Application Publication
(10) Pub. No.: US 2003/0115040 A1
(43) Pub. Date: Jun. 19, 2003

(54) International (multiple language/non-english) domain name and email user account ID services system

(76) Inventor: Yue Xing, Edmonton (CA)

Correspondence Address: Abraham N. Seidman, LAW OFFICE OF ABRAHAM SEIDMAN & ASSOCIATES, P.O. BOX 16603, Beverly Hills, CA, 90209, US

(21) Appl. No.: 09/780,810

(22) Filed: Feb. 9, 2001

(51) Int. Cl. G06F 17/20

(52) U.S. Cl. 704/8

(57) ABSTRACT

Aim of this invention is to place those billions of people on this planet who are not English-speaking but who want to have, or access, an appropriate domain name, on an equal footing with the English speaking populations. An embodiment of the invention proposed herein employs a translation database which has an entire set of international domain names, which can be in any suitable coding format, as an entry corresponding to a valid and current domain name definition (English-based domain name) or an IP address. This method fits into the current domain name system (DNS), system without generating conflicts, such as producing an unwanted duplicate domain name (DN). This method also has the flexibility, advantageously, to work with any language and character set. The DN/ML-DN to IP resolution scheme forms the basis of this invention. The ML-DN client does not talk to a normal DNS, except in the special case when the ML-DN is actually a DN (normal English one). The normal DNS dose not understand ML-DN and cannot translate a ML-DN request to a normal DN request. The ML-DNS translates the ML-DN request to a normal DN request. Then either the ML-DNS server or the ML-DN client can send the translated ML-DN, i.e. a normal DN, to a normal DNS to get the corresponding IP address. The choice of server or client is based on considerations of optimization of speed and ease of programming. Both approaches can be used.

### BACKGROUND OF THE INVENTION

This invention relates to multi-lingual domain names, translation between multi-lingual and normal Internet domain names and domain name routing protocols on the Internet. It also relates to Unicode (see The Unicode Standard, Version 3 by Unicode Consortium, The Unicode Consortium, Addison-Wesley Publishing Company, published Feb. 11, 2000, 1072 pp.)

Throughout man's history there have been interconnecting networks, some of which include the situation of a language group of one network requiring translation to move smoothly onto another node or network. Examples of these include the road systems of the Inca Kingdom in the region of Peru, of the Roman Empire, and of China under various dynasties. More recently, by 1838, Samuel Morse introduced long-distance wired binary communication, Morse code and the telegraph. With the advent of the telephone and the computer, modern communication networks materialized.

Today the Internet is worldwide communication network. In a sense it originated in the United States and so has taken on a flavor of the English-speaking word in its naming protocols used to designated destinations and sources. However, the majority of people of the world use, or at least are fluent in, non-English languages. If one subtracts off the populations of the United States, the United Kingdom, Ireland, Canada, and Australia, one is still left with five-plus billion total world population minus three-tenths billion, or some 4.7-plus billion non-native English-speakers.

The Internet is fast becoming a significant market place in itself as well as providing a commercial information network. The Internet has opened up worldwide interconnectivity and information sources. Non-English speaking individuals and commercial firm of non-English speaking countries are significant players on the Internet. Most international corporations have web pages available on the Internet. It should be noted, however, that international companies tend to have different names, which consist of different characters, in different languages.

Recognizing that the Internet is still very much part of an English-speaking technical world, it is desirable to expand the domain name (DN) system to include multi-language (ML) domain names, while retaining as much as possible the substance and the flavor of the current Domain Name Specification as described in Network Working Group's Request for Comments (RFC) 1035 and RFC 1034. A reliable and flexible method for multi-language domain names (ML-DN) is needed. This method for the multi-language domain names should fit into the current system without producing name conflicts or requiring major restructuring of the Internet or its protocols. Ideally it should require a minimum new resources for its implementation.

Similar and parallel requirements apply as well to the multi-language e-mail user account identification (ML-UID) as to the multi-language domain name (ML-DN), where the regular e-mail account identification is ID. Also, such requirements apply to the multi-lingual URLs.

Kapoor (U.S. Pat. No. 5,884,038) indicates a method for providing an Internet protocol address with a domain name server based on a static array which apportions the web servers among the client domains that most frequently access the web servers. Nitta et al. (U.S. Pat. No. 4,641,264) shows a method of automatic translation between natural languages utilizing parsing and lexicon storage look-up. Kollin et al. (U.S. Pat. No. 4,774,665) invented a system for retrieving information from a plurality of remote database having at least two different languages. Information from a selected database is downloaded and then examined off-line. McGarvey (U.S. Pat. No. 5,777,989) shows an enhanced name resolution for machines in several domains. The host is configured in more than one primary domain name server.

One approach to the multi-lingual Internet has been described by the iDNS working group (Asia Pacific Networking Group Internationalized Domain Name Server Working Group coordinating with the Internet Engineering Task Force). This approach is further described on the Internet at the site: “http://www.iDNS.org/”. It translates the foreign non-English characters into Unicode (www.unicode.org) and then converts them to a double byte English equivalent (www.idns.org). The iDNS working group itself has noted certain limitations in this approach. It may cause identical coding sometimes, i.e., an English domain name generated by the iDNA approach from a non-English charter domain sometimes conflicts with an existing English based domain name. Also, the available length for the international language name is more limited since every international character in Unicode requires the equivalent of two English-number characters to accomplish the coding.

A more versatile naming system would be more compatible with the international growth of the Internet. The DNS (Domain Name System) is the on-line distributed database system used to map human-readable machine names into IP (Internet Protocol) addresses. DNS servers throughout the connected Internet implement a hierarchical namespace that allows sites freedom in assigning machine names and addresses. The DNS also supports separate mappings between mail destinations and IP addresses.

The approach presently used to resolve domain name is analyzed here. As shown in FIG. 1a (prior art), the client workstation A 1001 wants to talk to the server workstation B 1002, but A only knows the domain name (DN) of B as “www.b-station.com” 1003. Consequently A 1001 needs to get B's 1002 IP (Internet protocol) address 1004, first. As an example, it might be 111.222.333.444 1004. Next A 1001 looks into its database and finds out that there is a DNS (Domain Name System) server D 1005, i.e., D's IP address. Now A send a DN/IP (Domain Name to Internet Protocol) translation request (as network route 1-R 1006, 4-R 1007) to D 1005 with a request for the IP (Internet Protocol) address of the domain name DN “www.b-station.com” 1003. When D 1005 receives the request from A 1001, D 1005 then checks its DNS database. Before D 1001 looks up its database for an IP match, however, it checks to determine whether the DN is in a valid format as defined in RFC 1035, i.e., less than 255 characters long, only has lower case characters from the 26 English alphabet, or “.”, or “-”.

If the DN is in the correct format and if D 1005 finds the corresponding IP address, i.e., 111.222.333.444 1004, for the DN “www.b-station.com” 1003, D 1005 then returns that IP address to A 1001 (by network route 4-G 1008, 1-G 1009). Otherwise if D 1005 cannot match the domain name (DN) to an Internet Protocol (IP) address, D 1005 will continue on and interrogate other DNSs 1011 (e.g., by network route 6 1010). If no match is found, an error message or error code is returned to A 1001. Once A 1001 has received the returned IP address (111.222.333.444 1004) of B 1002 from D 1005 it can start talking to B 1002 (by network route 1-B 1012, 5-B 1013).

An internet is a network which comprises at least the Internet.

### SUMMARY OF THE INVENTION

The aim of this invention is to place those billions of people on this planet who are not English-speaking but want to have, or access, an appropriate domain name, on an equal footing with the English speaking populations.

The invention proposed herein employs a translation database which has an entire set of international domain names, which can be in any suitable coding format, as an entry corresponding to a valid, by current domain name definition, English based domain name or an IP (Internet Protocol) address. This method, advantageously, fits into the current domain name system, or DNS, system without generating conflicts, such as producing an unwanted duplicated domain name (DN). This method also has flexibility, advantageously, to work with any language and character set.

The DN/ML-DN to IP resolution scheme forms the basis of the invention. The ML-DN client does not talk to normal DNS, except in the special case when the ML-DN is actually a DN(normal English one). The normal DNS does not understanding ML-DN and cannot translate a ML-DN request to a normal DN request. The ML-DN translates the ML-DN request to a normal DN request. Then either the ML-DNS server or ML-DN client can send the translated ML-DN, i.e. a normal DN to a normal DNS to get the corresponding IP address. The choice of server or client is based on the considerations of optimization of speed and ease of programming. Both approaches can be used.

A fully functional ML-DNS will recognize DN as well. When ML-DNS is widely accepted, DNS will then be a subset of ML-DNS.

Similarly, a multi-lingual email user account ID (ML-MUID) can also be used with the use of a user account translating table (database). The creation of new account directories is not needed.

Again, similarly, a multi-lingual URL (universal resource locator) can also be incorporated with the Internet system utilizing a resource locator translator so the Internet system will have available to, and can usefully handle, both the regular URL's and the multi-lingual ML-URL's.

### BRIEF DESCRIPTION OF THE DRAWINGS

The above and other features and advantages of the invention will be more apparent from the following detailed description wherein:

FIG. 1a (prior art) illustrates the method of the DN system in the network environment;

FIG. 1b shows a working method of the ML-DN system in the network environment;

FIG. 2 shows a block diagram of the working method of the ML-DN System on the Client Side;

FIG. 3 shows the block diagram of the working method of the ML-DN System on the Server Side;

FIG. 4 shows the block diagram of the working method of the ML-Email UID System on the Client Side;

FIG. 5 shows the block diagram of the working method of the ML-Email UID System on the Server Side;

FIG. 6 shows the ML-DN/DN resolving scheme.

### DETAILED DESCRIPTION OF THE PREFERRED EMBODIMENTS

The following description is the best mode presently contemplated for carrying out the invention. This description is not to be taken in a limiting sense, but is merely made for the purpose of describing the general principles of the invention. The scope of the invention should be determined with reference to the claims.

The multi-language domain name (ML-DN) system enables the usage of multiple language domain names interwoven seamlessly into the current system based on the current domain name server system. The current domain names are defined in the Internet Request For Comment document, RFC 1035. The current domain name is English (or Latin) letter-based only name, which utilizes only alphabet letters a to z, numbers 0 to 9 and symbols “.” and “-”.

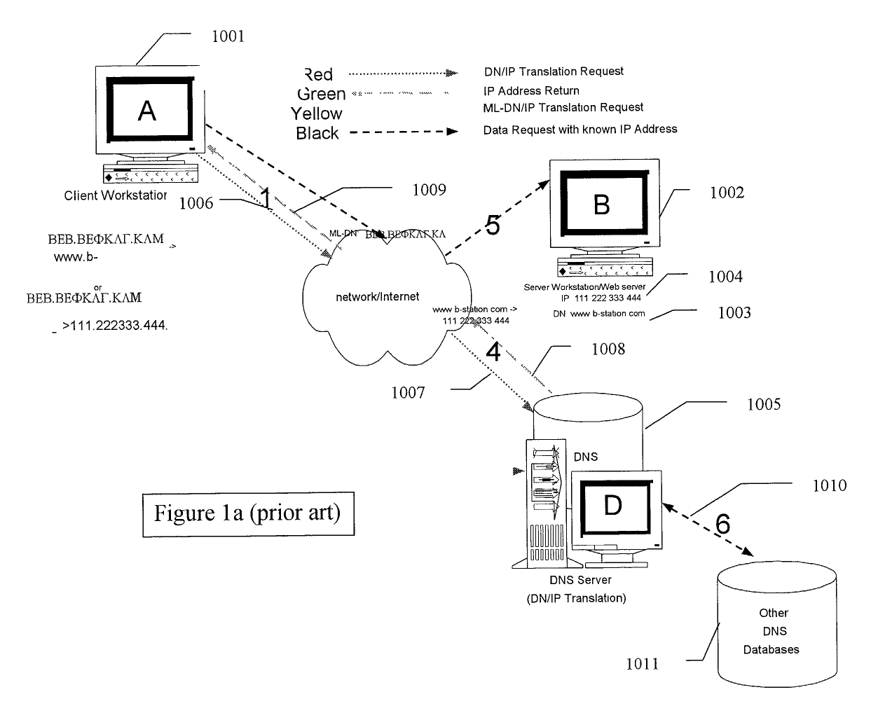

The description of the preferred embodiments of the multiple language (ML) domain name system (DNS) starts with FIG. 1b. FIG. 1b shows an embodiment of the invention for resolving both domain name system (DNS) and multiple language domain name system (ML-DNS) domain names.

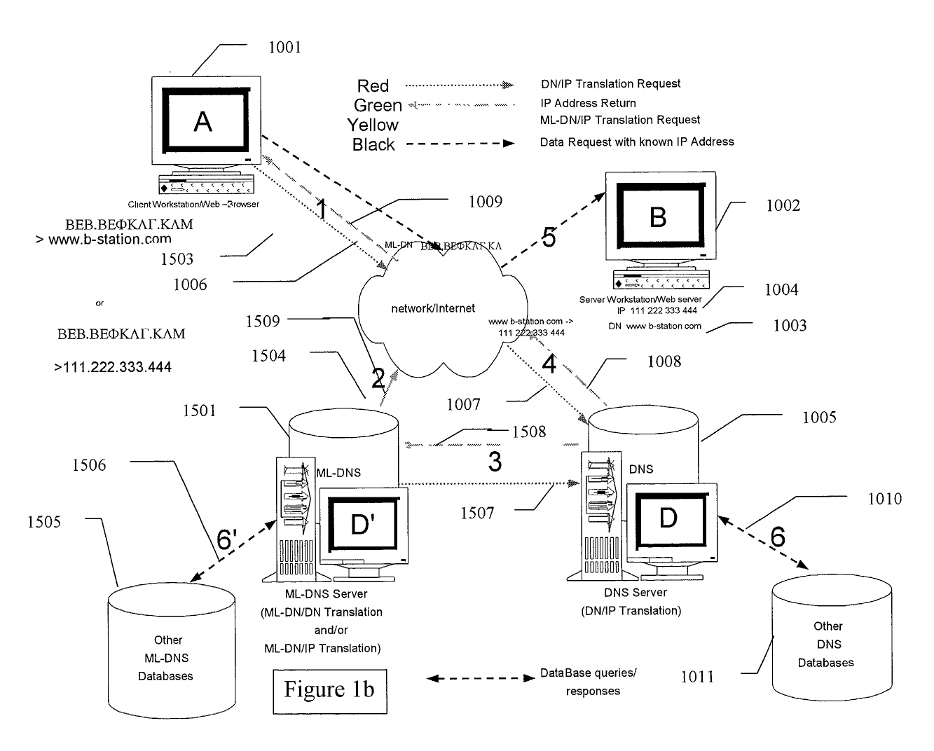

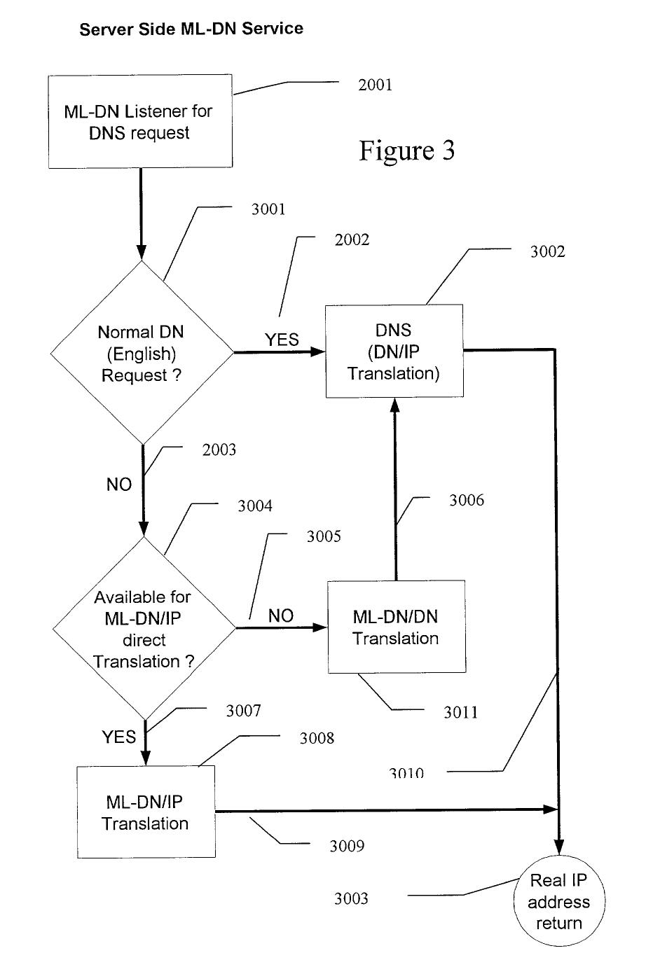

The ML-DNS is indicated as server D′ 1501 on FIG. 1b. In this embodiment of the invention, B 1002 has an international domain name, for example, “BEB.BEΦ.KΛΓ.KΛ” 1502 as well as its English language domain name (DN):“www.b-station.com”. If A 1001 wants to talk to B 1002 and A 1001 prefers to use the name “BEB.BEΦKΛΓ.KΓM” 1502 it cannot use the normal DNS, since it won't work with the invalid name “BEB.BEΦKΛΓ.KΛM” 1502. However, in this embodiment of the invention, A 1001 makes use of the ML-DNS (multi-lingual domain name server) D′ 1501. The client workstation A 1001 sends the ML-DN/IP translation request to D′ 1501 (by network route 1-Y 1503, 2-Y 1504). Upon receiving the request, D′ 1501 first checks 3001 to determine if the request is a normal one, i.e., a normal English domain name (as shown in FIGS. 2 and 3). Upon examination, should the DN be a normal English one, D′ 1501 sends a DN/IP translation request to D 1005 and upon receiving the IP address, 111.222.333.444 1004 D′ 1501 sends it back to A 1001. In a case like this, D′ 1501 works just like a DNS relay server.

When the received DN is a ML-DN, the server checks to determine whether it's available for direct translation of the ML-DN to an IP (111.222.333.444). In this circumstance, the ML-DNS and DNS databases are effectively integrated. In another circumstance, the direct translation is not available. This is more often situation. Consequently, the server checks its ML-DN to DN translation database for a valid DN match, i.e. translates “BEB.BEΦKΛΓ.KΛM” to “www.b-station.com”. When the server does not find a valid DN match it interrogates other ML-DNS, as is indicated by network route 6′.

Then the DN “www.b-station.com” will be passed to D 1005 as a normal DN/IP translation request (by network route 3-R 1507 as shown in FIG. 1b). Once the IP (111.222.333.444) is received at D′ 1501 (by network route 3-G 1508 as shown in FIG. 1b), it is returned to A 1001 (by network route 2-G 1509, 1-G 1009 as in FIG. 1b).

The ML-DN database, in a preferred embodiment, requires a unique coding system for each language character set. Because there are sometimes more than one coding system for each language character set, a converting processing is necessary in those cases for the ML-DNS system. In one embodiment, such a procedure can be implemented on the server side with special message formatting rules. For example, users may be required to use a language-coding flag string, or a particular pre-specified coding system. In a more preferred embodiment, this converting procedure is implemented on the client side to speed up the ML-DN/IP translation.

The Unicode is a preferred candidate for the implementation of the unique language coding system. Although the current 16-bit Unicode ends to result in large files, it can, advantageously, resolve many conflicts caused by other coding systems. One can see that the embodiment of the ML-DN system is set up as a symmetrical analog to the existing DN.

As shown in FIG. 2, the input DN string 2001 is examined on the client side before being sent out. If 2002 the DN string 2001 is a normal (English) one then it will be either sent directly to a normal DNS or it will be encoded with a language (English) indicating word 2006 before being sent out to the ML-DNS as a ML-DN/IP translation request. If 2003 the DN string 2001 is a ML-DN, then a converting process 2003 will be employed in order to convert the string coding to a unique one for the detected language 2004 character set. When the language character set has been detected 2004, the DN input string is translated to a Unicode representation 2005. Then the converted ML-DN string is encoded with a language indicating word, i.e., a language flag header 2006, before being sent out to the ML-DNS 2007.

In an embodiment of this invention, a root ML-DNS database is maintained, worldwide. The root ML-DNS database is divided into sub-root database according to different language character set categories worldwide. The root ML-DNS databases hold all the registered ML-DNS, which are updated on a regular basis. All the other client ML-DNS databases 1505 get the updates from the root databases (by way of route 6′ 1506 in FIG. 1b). The ML-DNS databases will work in a way analogous and parallel to the current DNS database.

The method for building and handling ML-DNS databases represent an enhancement and improvement of the existing system of DNS database methods (RFC 1035, RFC 1183 and RFC 1664). The invention comprises an improvement over the current DNS system. The ML-DNS root databases are not typically a single database residing at one physical site. The database usually consists of multiple sub-root databases maintained on different sites, even, for example, in different countries. In referring to a singular database, the usage, here, is meant to apply, also, to this plurality of data repositories. One embodiment of the invention has a format of the ML-DNS ML-DN/IP mapping set of databases as follows. For each ML-DNS sever there is a set of database for holding the multiple language Resource Records (ML-RR's as an enhancement of RR's for normal DNS). The types of the ML-RR's include as enhancements of ordinary DNS resource records SOA, NS, and AM. The SOA (Start Of Authority) is a keyword used with DNS to denote the beginning of the records for which a particular server is the authority. Other records in the server are reported as non-authoritative. SOA (Start Of Authority), NS (Name Server) records and AM (Address Mapping) records for the set of DNS databases have the counterparts: (1) ML-Start-of-Authority (ML-SOA) Records, (2) ML-Name Server (ML-NS) Records, (3) ML-Address Mapping (ML-AM) Records. The formats for the DNS RR's and zone files are defined in RFC 1035.

The syntax used in ML-DNS database files is an enhancement of that used in the DNS database, where the record fields for the ML-DN are be in a Unicode format, i.e., a 16-bit hex address format (xxxx, where x=0-9, A-F) for every character in the ML-DN and where “..” is used as the separation symbol for the ML-DN labels instead of “.” as in normal DN's. In addition, the corresponding types for labeling the different records-SOA, NS and AM are replaced by ML-SOA, ML-NS and ML-AM. For the ML-DNS there is one master zone file, which have a ML-SOA record with the following format:

<owner><ttl>IN ML-SOA<zone file source><mailbox>(<serial><refresh><retry>

<expire><m-ttl>)

which is an exact duplicate of SOA for DNS except with the string ML-SOA instead of the string ML.

The ML-NS records in the following format, resembling NS records for the DNS with NS replaced by ML-NS:

<owner><ttl>IN ML-NS<host.domain-name>

The control entries for designating the file names of ML-AM (multi-lingual address mapping) record databases for every valid language character set are:

$ORIGIN <domain name>[<comment>]

$LANGUAGE<language-character-set identifier><domain-name in Unicode format for current language-character-set>[<comment>]

$INCLUDE<file name><language-character-set identifier>[<domain-name>][<comment>]

Then in the database file for a given language-character-set, the ML-AM (multi-lingual address mapping) records will have the following formats:

<domain-name in Unicode for current language-character-set>

<language-character-set identifier>IN ML-AM <valid English domain-name>

The ML-DNS database can be constructed following the above method examples using reliable and logical record formats to insure a reliable service.

The flow of the translation process for converting the “b-station's” Russian DN (in Unicode) to a normal IP address is described below. Russian DN (Unicode)->(ML-DNS)->normal English DN (non-Unicode)->(D)NS)->IP address

The process {Russian DN (Unicode)->(ML-DNS)->normal English DN} is discussed in detail in terms of a level-by-level, i.e., domain level, top-level-domain (tld) on down, resolving method. Each time one level of the ML_DNS domain name is resolved, i.e., converted to a normal English DN fragment, the normal English DN replaces that ML-DNS DN fragment. In order to tell what part of the ML-DNS name string has already been resolved the “..” (“double dot”) fragment serves as a separator between the resolved part and the unresolved part. That unresolved part is further resolved. This can happen in the same or another ML-DNS server. A Top Level ML-Domain Name translation database (the size of which is relatively small) can be placed on every ML-DNS server in order to speed up the translation process.

The working method for the ML-DN resolver is an enhancement of the working method of a normal DN resolver. The ML-DN resolving process is as follows. The local ML-DNS resolver first checks the local ML-DNS database or cache files (after the initial string code converting process 2005, FIG. 2) to determine if it is possible to map the entire ML-DN 3001 (FIG. 3) to normal DN 3002 locally. See FIG. 3. If not 2003, it then queries a specified ML-DNS server 3004. The ML-DNS system is configured such that every ML-DNS 3004 server is able to translate the Multi-Lingual-Top Level Domain (ML-TLD) names to the normal TLD's. Since the number of TLD's is quite limited the ML-DNS can be configured in this manner. In the case where there is an increase in the number of TLD's, one TLD ML-DNS can be set up for the ML-TLD/TLD mapping).

When a ML-DN listener receives a DNS request 2001, it first tries to determine if the request is a normal (English) request 3001. If it is, then a normal DNS 3002 server can translate the domain name to an Internet Protocol address 3003. If the request is not a normal (English) request 2003, then a ML-DNS server is queried as to its availability for direct translation of the ML-DN to an IP address. If it is available for this translation 3007, then that translation is carried out 3008 and a real IP address will be returned 3003. If it is not available 3005 for direct ML-DN/IP translation, the first step is to translate from ML-DN to DN 3011. Once the translation for the DN 3011 is achieved, then the DN is sent 3006 to the DNS 3002 for translation from DN to IP, which is then sent on 3010 to return a real IP address.

There is a ML-DNS 3004 server under every TLD. For example, there is a “mldns.com” for the COM domain, which is responsible for mapping the second level part of the domain name. And for every second level domain there is another ML-DNS server 3008, and so on. A physical server can host several domains. Thus, the number of servers needed for ML-DN to/from DN mapping is not necessarily large. The iterative process 3001, 3004, 3006, 3002, 3008, 3003 will be carried on until the entire ML-DN has been mapped to the DN 3009, 3010. After the mapping, the normal DNS query will be made to get the desired IP address 3003.

The IP packet format 3008 of M-DNS queries can take the same form as for the DNS queries with the use of the appropriate type in the <Type> and <>fields.

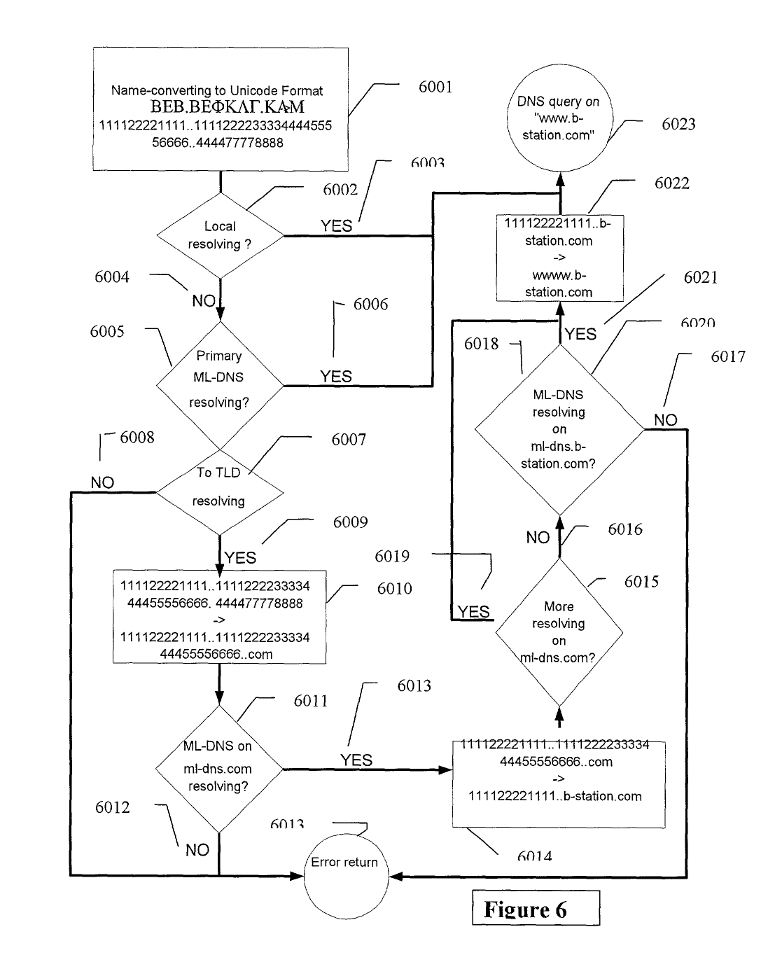

An example of an embodiment of the ML-DN-/DN resolving method is shown on FIG. 6. The example treats a case where the ML-DNS database maps mapping “BEB.BEΦKΛΓ.KΛM” 6001 to “www.b-station.com” 6023 assuming the Unicode IP address: 111.222.333.444. The first “..” is part of the translated code while the second “..” may represent the separation between the first “translated” and the second “un-translated” part. In this example, the Russian language domain name (ML-DN) is “BEB.BEΦKΛΓ.KΛM” and has the ML-DN designated address of “111122221111..111122223333444455556666..444477778888” 6001.

In the boot zone file listings below, please note that “,” indicates the start of a comment. First the domain name to be resolved 6001 is checked to determine if it can be resolved locally 6002. If it can 6003, one has a DNS query on “www.b-station.com” 6023. Next, a check is made to determine whether the primary ML-DNS 6005 can resolve the domain name. If it can 6006, then one forwards the query to “www.b-station.com” 6023.

If the primary ML-DNS 6005 cannot resolve the domain name, then one progresses on to TLD 6007 (top level domain) resolving. If it cannot 6008, then an error 6013 is returned. If the primary ML-DNS 6005 can begin to resolve the ML-DN it proceeds to do so. The resolution of the last 12 integers “444477778888” to the top-level domain (TLD) “com” is shown 6010. The resolving continues on 6011. If no further resolution can be done 6012, then an error is returned 6013. If further resolution can be done 6024, the next resolution 6014 is that of “111122223333444455556666” to “b-station”. The resolution so far is:

“111122221111..111122223333444455556666..444477778888

to

“111122221111..b-station..com”.

Next, one determines if more resolving on ml-dns.com 6015 can be done. If yes, 6019, one proceeds to resolve “111122221111.b-station.com” to “www.b-station.com” 6022. If no further resolving 6016 can be done on “ml-dns.com”, then one attempts resolving “ml-dns.b-station.com” 6020. If no further resolution 6017 can be done, an error is returned 6013. If further resolution can be done, then one proceeds to further resolve “111122221111” into “www” 6022. In all successful ML-DNS name resolutions, one then proceeds as a DNS query on “www.b-station.com” 6023.

The iterative query chain starts on the DNS server for TLD “COM” i.e., the top level domain “.com”.

| Com | IN | ML-SOA mlns.com | root.mlns.com |
|---|---|---|---|
| (169712 | 3200 | 7200 940000 | 96000); ML-SOA record |

IN ML-NS mlns. com; ML-NS record
$ORIGIN com
&LANGUAGE 110 444477778888
$INCLUDE ru_name.db 110; language identifier for Russian

An inquiry is then sent to mldns.b-station.com:

Boot zone File on mldns.b-station.com

| b-station.com | IN | ML-SOA | mlns.b-station.com | root-station.com |
|---|---|---|---|---|
| (19712 | 1800 | 3600 | 640000 86000); | ML-SOA record IN ML-NS |

mlns.b-station.com; ML-NS record

SORIGIN b-station.com

SLANGUAGE 110111122223333444455556666.444477778888

$INCLUDE ru_name.db 110; language identifier for Russian

then in file name ru_name.db one finds:

111122221111 110; IN ML-AM www

Consequently, the name mapping has been accomplished.

Email

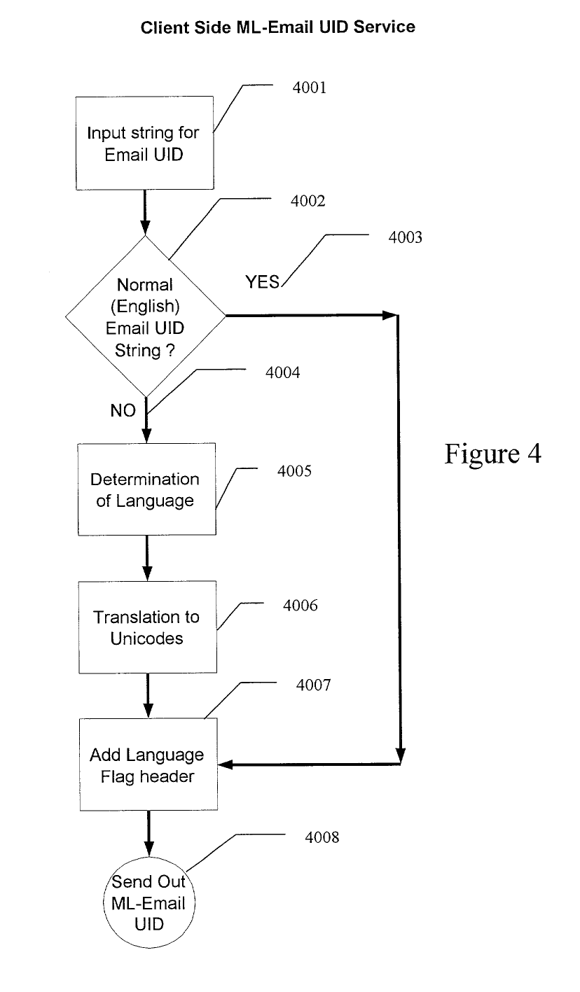

The multiple language-enabling schemes can be applied to the Email system similarly. FIG. 4 shows the client side multi-language user account ID (ML-UID) working scheme. The input string of email 4001 user ID is examined first 4002 before being used in the email header. If the ID is a normal one 4003 then it is used just as it is, or preferably in this embodiment, it can be encoded with a language (English) indicating flag word 4007 then added in to the mail header 4008. If the ID is a ML-UID 4004 then it will be converted to a unique coding format 4006 for the detected language 4005 character set in Unicode, encoded with a language indicating flag word 4007 and then added in to the mail header 4008.

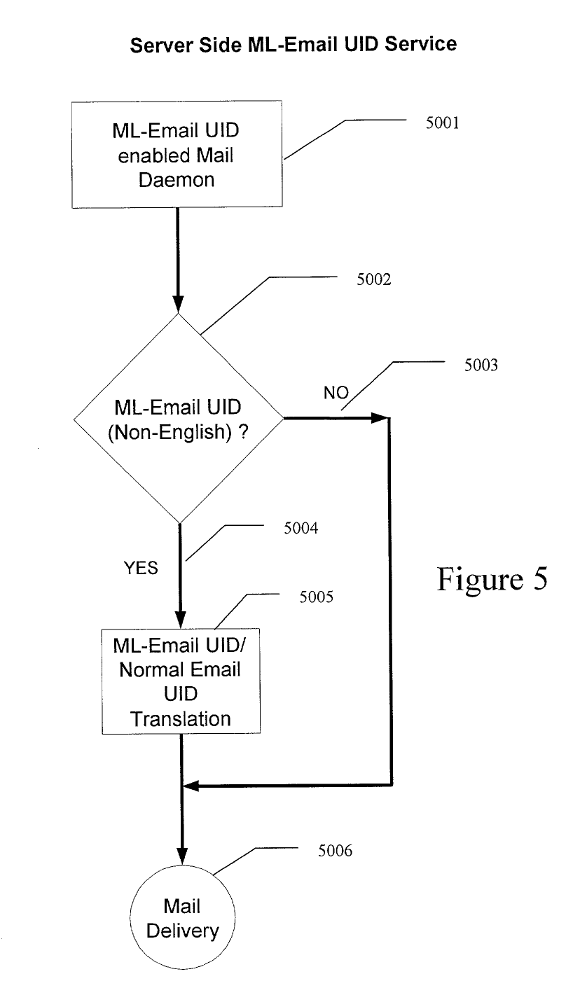

As for the server side (as shown in FIG. 5) a ML-UID aware mail daemon 5001 is employed. The mail daemon 5001 checks the UID 5002 in the mail header in case the UID is a normal (English) one 5003 it just sends it for normal mail delivery 5006. If the UID turns out to be a ML-UID 5004, it checks a ML-UID to UID translation database 5005 to find out the corresponding normal UID (in English), and then it sends the mail to the account with the found out UID 5006.

URL

The Uniform Resource Locator (URL) is the combination of domain name (DN) sub domain name (sub-DN) and the server path name. For the ML-URL the ML-sub-DN will either converted to normal (English) sub-DN together with ML-DN or transferred to the server with the parent DN and then converted there, using the same converting mechanism as shown above. The conversion is the same by either route. The server path name part of the ML-URL (ML-URL path name) is treated the same way as for the ML-UID. The resulting string shall be passed to the server with the identified DN, where the converting of the ML-URL path name to normal URL path name by using a translating database. The server must handle multiple languages.

The database structures for mapping ML-UID ad path name part of ML-URL should be the same. As described above for ML-DNS Database. An enhancement uses two new types of records:

ML-User ID (ML-UID) Records;

ML-URL Path (ML-P) Records;

There is a master file for each of the databases, which includes the information for mapping from different language character set:

$Origin <domain name>[<comment>]

$LANGUAGE<language-character-set identifier><domain-name in Unicode format for current language-character set>[<comment>]

$INCLUDE<file-name><language-character-set identifier>[<domain name>] [comment]

And the enhanced formats for ML-UID Records are:

<user ID in Unicode format for current language-character-set><language-character-set identifier>IN ML-UID<Valid English user ID>

Then the formats for ML-P Records are:

<path name part of URL in Unicode format for current language-character-set>

<language-character-set identifier>IN ML-P<Valid English pathname part of URL.>

The process for resolving the ML path names will be localized on the server with the domain name. But the resolving scheme can also be iterative, as is the domain name resolving scheme. In other words the translation database can be placed under every directory, which is designed to have sub-directories or files with ML names. Thus the full directory name can be translated level-by-level starting from the very top level to the very bottom level just by checking the database file holding the ML-P records for the items under the current level. The separation symbol “/” for separating different levels in the pate name format can be replaced by “//” for a path name recorded only in 16-bit coding format for Unicode (shown in the text above). Also each database file can have multiple entries mapping to the same normal path name string with the same language character set identifier.

For all the database mentioned above all the ML string are recorded in a 16-bit coding format (see above) by suggestion a more efficient method can be employed to reduce some unnecessarily long strings. Since, except for Chinese Japanese and Korean characters which all derive from ancient Chinese characters, most language character sets are “alphabetical” in nature, similar to English. Therefore the amount of necessary characters for these “alphabetical” character set is much limited, say, well under 256 different characters.

In that case the coding can be recorded as a base code (in 16-bit form) plus a shifting code (in 8-bit form). Then the string primarily can be recorded in 8-bit formats. Consequently the record size can be reduced greatly. Some control information may be included in the string for the implemented coding procedure.

There are many different coding systems for a number of languages, for example, Chinese has GB, Big5; Russian has KOI8-R, CP866; Japanese has SJIS, EUC; Korean has KSC5601; French has ISO-8859-1 and Finnish has ISO-8859-1. Consequently, in one embodiment of the invention, a system for converting different coding versions of a single language character set to a unique coding system is used. This can be done either on the server side or on the client side.

A modified version of UNIX Sendmail for ML-UID can be used to do the ML-UID/UID mapping. A modification for an APACHE Web Server can be programmed to enable the ML path mapping. The ML-UID database only resides on the appropriate Mail Server and ML-P-Web Server.

One method for simplifying the client part of the job that consists of determining the language character set is outlined here. There are certain characters in each language-character-set coding system, which or the combination of which, are distinctive for the same English string (in term of the meaning of the string). So we can use a specific ML-word as part of the ML-URL. This ML-word should appear the same, and mean the same thing, for the same language, but at the coding level it is different for different coding sets. The same coding system is to be used for the whole string of URL and/or the e-mail address. Thus, the language character set can be easily verified. For example, the URL “www.b-station.com” in Russian may look like “BEB.BEΦKΛΓ.KΛM.”, the counterpart of the word “www” in Russian is defined as “BEB” which appears the same with any Russian coding system. But at the real coding level it may looks “345678” for one Russian character set and “129876” for the other one. By using a small translation table on the client side it will be very easy to figure out what language character set is used by the user. The most foolproof method, of course, may be just to let the user identify what language character set he is using when he is entering the ML-URL, ML-UID or ML-DN.

All the above mentioned network activities are designed to be carried out in an IP network environment. But one should be able to use similar scheme with other network protocols. In terms of Server side programming the core technology may be based on UNIX BIND programs.

The multi-lingual method maps only the ML-DN to a valid normal DN. If one already has a normal (English) DN, the cost for setting up a ML-DN is much less. This name system can be run on any computer connected to the Internet. It will work independently or co-operatively with the current DNS for converting domain names to IP addresses.

While the invention herein disclosed has been described by means of specific embodiments and applications thereof, numerous modifications and variations could be made thereto by those skilled in the art without departing from the scope of the invention set forth in the claims.

It is claimed that:

1. A method for mapping multi-lingual( non-English) domain names to existing domain names of an internet network system comprising the steps:
(a) maintaining a table of English domain names with corresponding multi-lingual (non-English) domain names;
(b) examining the incoming Domain Name to determine if it is an English Domain Name; if so, sending said English Domain Name to an Internet Domain Name System for resolution on an internet;
(c) examining the incoming Domain Name to determine if it is a non-English multi-lingual Domain Name; if so, replacing said non-English Domain Name by a known English Domain Name which corresponds to the multi-lingual non-English Domain Name; and wherein said English Domain Name is sent out to an Internet Domain Name System for resolution on an internet;

2. The method of claim 1 further comprising the step of:
utilizing the Internet as the internet.

3. The method of claim 1 further comprising the step of:
utilizing Unicode as the multi-language character set coding system.

4. The method of claim 1 comprising further the step of:
utilizing a separate ML-DNS system in parallel with current DNS systems.

5. The method of claim further comprising the step of:
utilizing a ML-DN string format similar to the existing English DN format, but with a character set equal to an extended character set which consists of all the characters in Unicode except for special reserved symbols including “.” and “@”.

6. A method for mapping existing (English) domain names of an internet system to multi-lingual (non-English) domain names comprising the steps of:
(a) maintaining a table of multi-lingual(non-English) domain names with corresponding English domain names;
(b) examining the incoming Domain Name to determine if it is an non-English multi-lingual Domain Name; if so, sending said Domain Name to a non-English multi-lingual Internet Domain Name Server for resolution on an internet;
(c) examining the incoming Domain Name to determine if it is an English Domain Name; if so, replacing said English Domain Name by a known non-English multi-lingual Domain Name wherein said multi-lingual Domain Name corresponds to the English Domain Name;
(d) sending said non-English multi-lingual Domain Name to a non-English multi-lingual Internet Domain Name System for resolution on an internet.

7. The method of claim 6 further comprising the step of:
utilizing the Internet as the internet.

8. The method of claim 6 further comprising the step of:
utilizing Unicode as the multi-language character set coding system.

9. The method of claim 6 comprising further the step of:
utilizing a separate ML-DNS system in parallel with current DNS systems.

10. The method of claim 6 further comprising the step of:
utilizing a ML-DN string format similar to the existing English DN format, but with a character set equal to an extended character set which consists of all the characters in Unicode except for special reserved symbols including “.” and “@”.

11. A method for mapping multi-lingual (non-English) domain names to existing domain names of an Internet network system and for mapping existing domain names of the Internet system to multi-lingual (non-English) domain names comprising the steps:
(a) maintaining a table of English domain names with a corresponding multi-lingual(non-English) domain names;
(b) maintaining a table of multi-lingual (non-English) domain names with corresponding English domain names;
(c) resolving for an English-required Domain Name portion of an internet, further comprising the steps of:
(i) examining an incoming Domain Name to determine if it is an English Domain Name; if so, sending said English Domain to an Internet Domain Name Server for resolution on the Internet;
(ii) examining the incoming Domain Name to determine if it is a non-English multi-lingual Domain Name; wherein said non-English Domain Name is replaced by a known English Domain Name which corresponds to the multi-lingual non-English Domain Name; and wherein said English Domain Name is sent out to an Internet Domain Name System for resolution on the Internet;
(d) resolving for an a non-English multi-lingual Domain Name-required portion of an internet, further comprising the steps of:
(iii) examining the incoming Domain name to determine if it is an non-English multi-lingual Domain Name; wherein said Domain Name is sent out to a non-English multi-lingual Internet Domain Name Server for resolution on an internet;
(iv) examining the incoming Domain Name to determine if it is an English Domain Name; if so, replacing said English Domain Name by a known non-English multi-lingual Domain Name wherein said multi-lingual Domain Name corresponds to the English Domain Name;
(v) sending said non-English multi-lingual Domain Name to a non-English multi-lingual Internet Domain Name Server for resolution on an internet.

12. The method of claim 11 further comprising the step of:
utilizing the Internet as the internet.

13. The method of claim 11 further comprising the step of:
utilizing Unicode as the multi-language character set coding system.

14. The method of claim 11 comprising further the step of:
utilizing a separate ML-DNS system in parallel with current DNS systems.

15. The method of claim 11 further comprising the step of:
utilizing a ML-DN string format similar to the existing English DN format, but with a character set equal to an extended character set which consists of all the characters in Unicode except for special reserved symbols including “.” and “@”.

16. A method for mapping multi-lingual (non-English) ML-UIDs to existing UIDs of an internet network email system comprising the steps:
(a) maintaining a table of English UIDs with corresponding multi-lingual (non-English) ML-UIDs;
(b) examining the incoming ML-UID or UID to determine if it is an English UID; if so, using said English UID directly for email UID resolution;
(c) examining the incoming ML-UID or UID to determine if it is a non-English multi-lingual ML-UID; wherein said non-English ML-UID is replaced by a known English UID which corresponds to the multi-lingual non-English ML-UID; and wherein said English UID is used directly for email UID resolution.

17. The method of claim 16 further comprising the step of:
utilizing the Internet as the internet.

18. The method of claims 16 further comprising the step of:
utilizing Unicode as the multi-language character set coding system.

19. The method of claim 16 further comprising the step of:
utilizing an identifying word (ML-word) in the ML-UID string for each language character set; wherein said word is distinct for each different coding of the same language character set.

20. A method for mapping existing UIDs of an internet system to multi-lingual (non-English) MIL-UIDs comprising the steps of:
(a) maintaining a table of multi-lingual (non-English) ML-UIDs with corresponding English UIDs (ML-UID/UID translation/mapping database);
(b) examining an incoming ML-UID or UID to determine if it is an multi-lingual (non-English) ML-UIDs; if so, utilizing said multi-lingual (non-English) ML-UID directly for email ML-UID resolution or an internet;
(c) examining the incoming UID to determine if it is an English UID; if so, replacing said English UID with a multi-lingual (non-English) ML-UID according to the ML-UID/UID translation/mapping database.

21. The method of claim 20 further comprising the step of:
utilizing the Internet as an internet.

22. The method of claims 20 further comprising the step of:
utilizing Unicode as the multi-language character set coding system.

23. The method of claim 20 further comprising the step of:
utilizing an identifying word (ML-word) in the ML-UID string for each language character set; wherein said word is distinct for each different coding of the same language character set.

24. A method for mapping multi-lingual (non-English) UIDs to existing UIDs of an internet network email system and for mapping existing UIDs of the Internet email system to multi-lingual (non-English) ML-UIDs comprising the steps of:
(a) maintaining a table of English UID's with corresponding multi-lingual(non-English) ML-UIDs;
(b) maintaining a table of multi-lingual (non-English) ML-UIDs with corresponding English UID's;
(c) resolving for an English-required portion of an internet, further comprising the steps of:
(i) examining the incoming ML-UID or UID to determine if it is an English UID; if so, utilizing said English UID directly for email UID resolution;
(ii) examining the incoming ML-UID or UID to determine if it is a non-English multi-lingual ML-UID; wherein, if so, said non-English ML-UID is replaced by known English ML-UID which corresponds to the multi-lingual non-English MI-UID; and wherein said English UID is used directly for email UID resolution;
(d) resolving for an a (non-English) multi-lingual ML-UID-required portion of an internet, further comprising the steps of:
(iii) examining an incoming ML-UID or UID to determine if it is an multi-lingual (non-English ) ML-UIDs; if so, utilizing said multi-lingual (non-English ) ML-UID directly for email ML-UID resolution on an internet;
(iv) examining the incoming UID to determine if it is an English UID; if so, replacing said English UID with a multi-lingual (non-English) ML-UID according to the ML-UID/UID translation/mapping database, for resolution on an internet.

25. The method of claim 24 further comprising the step of:
utilizing the Internet as an internet.

26. The method of claims 24 further comprising the step of:
utilizing Unicode as the multi-language character set coding system.

27. The method of claim 24 further comprising the step of:
utilizing an identifying word (ML-word) in the ML-UID string for each language character set; wherein said word is distinct for each different coding of the same language character set.

28. A method for mapping multi-lingual (non-English) ML-URL path names to existing URL path names of an internet network system comprising the steps of:
(a) maintaining a table of multi-lingual (non-English) ML-URL path names with corresponding English URL;
(b) examining an incoming ML-URL path name or URL path name to determine if it is an English URL path name; if so, utilizing said English URL path name directly for URL path name resolution on an internet;
(c) examining the incoming ML-URL path name or URL path name to determine if it is a non-English multi-lingual ML-URL path name; if so, replacing said non-English ML-URL path name by a known English URL path name which corresponds to the multi-lingual non-English ML-URL path name; and wherein said English URL path name is used directly for URL path name resolution on an internet.

29. The method of claim 28 further comprising the step of:
utilizing the Internet as the internet.

30. The method of claims 28 further comprising the step of:
utilizing Unicode as the multi-language character set coding system.

31. The method of claim 28 further comprising the step of:
utilizing an identifying word (M-word) in the ML-UID string for each language character set; wherein said word is distinct for each different coding of the same language character set.

32. A method for mapping existing URL path names of an internet system to multi-lingual (non-English) ML-URL path names comprising the steps of:
(a) maintaining a table of English URL path names with corresponding multi-lingual (non-English) ML-URL path names (ML-URL path name/URL path name translation/mapping database);
(b) examining an incoming ML-URL or URL path name to determine if it is an non-English multi-lingual ML-URL path name; if so, said ML-URL path name is utilized for ML-URL path name resolution on an internet;
(c) examining the incoming ML-URL or URL path name to determine if it is an English URL path name; if so, replacing said English URL path name by a non-English ML-URL path name which corresponds to the multi-lingual non-English ML-URL path name; and wherein said non-English ML-URL path name is used directly for path name resolution on an internet.

33. The method of claim 32 further comprising the step of:
utilizing the Internet as the internet.

34. The method of claim 32 further comprising the step of:
utilizing Unicode as the multi-language character set coding system.

35. A method for mapping multi-lingual (non-English) ML-URL path names to existing URL path names of an internet network system and for mapping existing URL path names of an internet system to multi-lingual (non-English) ML-URL path names comprising the steps of:
(a) maintaining a table of multi-lingual (non-English) ML-URL path names with corresponding English URL(ML-URL path name/URL path name translation/mapping database);
(b) maintaining a table of English URL path names with corresponding multi-lingual (non-English) ML-URL path names; (URL path name/ML-URL path name translation/mapping database);
(c) resolving for an English-required portion of an internet, further comprising the steps of:
(i) examining an incoming ML-URL path name or URL path name to determine if it is an English URL path name; if so, utilizing said English URL path name directly for URL path name resolution on an internet;
(ii) examining the incoming ML-URL path name or URL path name to determine if it is a non-English multi-lingual ML-URL path name; if so, replacing said non-English ML-URL path name by a known English URL path name which corresponds to the multi-lingual non-English ML-URL path name; and wherein said English URL path name is used directly for URL path name resolution on an internet.
(d) resolving for an a (non-English) multi-lingual ML-UID-required portion of an internet, further comprising the steps of:
(iii) examining an incoming ML-URL or URL path name to determine if it is an non-English multi-lingual ML-URL path name; if so, said ML-URL path name is utilized for ML-URL path name resolution on an internet;
(iv) examining the incoming ML-URL or URL path name to determine if it is an English URL path name; if so, replacing said English URL path name by a non-English ML-URL path name which corresponds to the multi-lingual non-English ML-URL path name; and wherein said non-English ML-URL path name is used directly for path name resolution on an internet.

36. The method of claim 35 further comprising the step of:
utilizing the Internet as the internet.

37. The method of claim 35 further comprising the step of:
utilizing Unicode as the multi-language character set coding system.

38. The method of using a client-side program to convert different language character-set coding of the same language to one unique language-character-set coding for that language.

39. A system based on at least one electronic processor and at least one computer for mapping multi-lingual (non-English) domain names to existing domain names of an internet network system and for mapping existing domain names of the Internet system to multi-lingual (non-English) domain names, comprising:
(a) a table of English domain names with corresponding multi-lingual(non-English) domain names;
(e) a table of multi-lingual (non-English) domain names with corresponding English domain names;
(c) resolution for an English-required portion of an internet, further comprising:
(i) an incoming Domain Name, examined to determine if it is an English Domain Name; if so, said English Domain is resolved on an Internet Domain Name System;
(iii) the incoming Domain Name, examined to determine if it is a non-English multi-lingual Domain Name; wherein, replacement of said non-English Domain Name is by an English Domain Name which corresponds to the multi-lingual non-English Domain Name; and said English Domain Name is resolved by an existing Internet Domain Name System on the Internet;
(d) resolution for an a non-English required portion of an internet, further comprising:
(iv) the incoming Domain name, examined to determine if it is an non-English multi-lingual Domain Name; wherein, if so, said Domain Name is resolved by an existing non-English multi-lingual Internet Domain Name System on the Internet;
(v) the incoming Domain Name, examined to determine if it is an English Domain Name; wherein, if so, said English Domain Name is replaced by a non-English multi-lingual Domain Name by the corresponding to the English Domain Name; wherein said non-English multi-lingual Domain Name is resolved by a non-English multi-lingual Internet Domain Name System on an internet;
(e) at least one electronic processor and at least one computer for examination and resolution of domain names;
(f) at least one storage media for storing said tables.

40. The system of claim 39 further comprising:
the Internet as the internet.

41. The system of claim 39 further comprising:
Unicode as the multi-language character set coding system.

42. A system based on at least one electronic processor and at least one computer for mapping multi-lingual (non-English) UIDs to existing UIDs of an internet network email system and for mapping existing UIDs of the Internet email system to multi-lingual (non-English) ML-UIDs comprising:
(a) a table of English UID's with corresponding multi-lingual(non-English) ML-UIDs;
(b) a table of multi-lingual (non-English) ML-UIDs with corresponding English UIDs;
(c) resolution for an English-required UID portion of an internet, further comprising:
(i) an incoming ML-UID or UID, examined to determine if it is an English UID; wherein, if so, resolution of said English UID directly by email UID resolution on an internet;
(ii) the incoming ML-UID or UID, examined to determine if it is a non-English multi-lingual ML-UID wherein, if so, replacement of said non-English ML-UID is by a known English ML-UID which corresponds to the multi-lingual non-English Ml-UID; and wherein said English UID is used directly for email UID resolution on an internet;
(d) resolution for an a non-English ML-UID required portion of an internet, further comprising:
(iii) the incoming ML-UID or UID, examined to determine if it is an non-English multi-lingual ML-UID; wherein, if so, said non-English ML-UID is used directly for email ML-UID resolution on an Internet;
(iv) the incoming ML-UID or UID, examined to determine if it is an English UID; if so, replacement of said English UID is by a non-English ML-UID which corresponds to the English UID; said non-English ML-UID is used directly for email NIL-UID resolution on an internet.
(e) at least one electronic processor and at least one computer for examination and resolution of domain names;
(f) at least one storage media for storing said tables.

43. The system of claim 42 further comprising:
the Internet as the internet.

44. The system of claims 42 further comprising:
Unicode as the multi-language character set coding system.

45. The system of claim 42 further comprising:
an identifying word (ML-word) in the ML-UID string for each language character set; wherein said word is distinct for each different coding of the same language character set.

46. A system based on at least one electronic processor and at least one computer for mapping multi-lingual (non-English) ML-URL path names to existing URL path names of an internet network system and for mapping existing URL path names of an internet system to multi-lingual (non-English) ML-URL path names comprising:
(a) a table of multi-lingual (non-English) ML-URL path names with corresponding English URL(ML-URL path name/URL path name translation/mapping database);
(b) a table of English URL path names with corresponding multi-lingual (non-English) ML-URL path names; (URL path name/ML-URL path name translation/mapping database);
(c) resolution for an English-required URL portion of an internet, further comprising:
(i) an incoming ML-URL path name or URL path name, examined to determine if it is an English URL path name; if so, utilization of said English URL path name directly for URL path name resolution on an internet;
(ii) the incoming ML-URL path name or URL path name, examined to determine if it is a non-English multi-lingual ML-URL path name; if so, replacing said non-English ML-URL path name by a known English URL path name which corresponds to the multi-lingual non-English ML-URL path name; and wherein said English URL path name is used directly for URL path name resolution on an internet;
(d) resolution for an a (non-English) multi-lingual ML-URL-required portion of an internet, further comprising:
(iii) the incoming ML-URL or URL path name, examined to determine if it is an non-English multi-lingual ML-URL path name; if so, utilizing said ML-URL path name for ML-URL path name resolution on an internet;
(iv) the incoming ML-URL or URL path name, examined to determine if it is an English URL path name; if so, replacement of said English URL path name by a non-English ML-URL path name which corresponds to the multi-lingual non-English ML-URL path name; and utilizing said non-English ML-URL path name is directly for path name resolution on an internet;
(e) at least one electronic processor and at least one computer for examination and resolution of domain names;
(f) at least storage media for storing said tables.

47. The system of claim 46 further comprising:
the Internet as the internet.

48. The system of claim 47 further comprising:
Unicode as the multi-language character set coding system.
